(19) United States
(12) Patent Application Publication
(10) Pub. No.: US 2009/0311381 A1
(43) Pub. Date: Dec. 17, 2009

(54) BEVERAGES COMPOSED OF WINE COMPONENTS

(76) Inventor: Susanne GARDNER, Atlanta, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/481,759

(22) Filed: Jun. 10, 2009

Related U.S. Application Data
(60) Provisional application No. 61/060,507, filed on Jun. 11, 2008.
(60) Provisional application No. 61/077,554, filed on Jul. 2, 2008.

(51) Int. Cl. A23L 2/52; A23L 2/00; A23F 3/00; A23C 9/152; A23L 2/02; A23L 2/38

(52) U.S. Cl. 426/66; 426/590; 426/597; 426/599; 426/580

(57) ABSTRACT

Described herein are beverages having a natural additive composed of one or more components derived from wine. In certain aspects, the beverages composed of one or more components derived from defortified wine have optional other additives. Components derived from defortified wine can be used to supplement an existing beverage or used to form a new beverage.

### CROSS REFERENCE TO RELATED APPLICATIONS

This application claims priority upon U.S. provisional application Ser. No. 61/060,507, filed Jun. 11, 2008 and U.S. provisional application Ser. No. 61/077,554, filed Jul. 2, 2008. These applications are hereby incorporated by reference in their entireties.

### SUMMARY

Described herein are beverages having a natural additive composed of one or more components derived from defortified wine. In certain aspects, the beverages composed of one or more components derived from defortified wine have optional other additives. Components derived from wine can be used to supplement an existing beverage or used to form a new beverage. The advantages of the invention will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### DETAILED DESCRIPTION

Before the present compositions and methods are disclosed and described, it is to be understood that the aspects described below are not limited to specific compounds, synthetic methods, or uses as such may, of course, vary. It is also to be understood that the terminology used herein is for the purpose of describing particular aspects only and is not intended to be limiting.

In this specification and in the claims that follow, reference will be made to a number of terms that shall be defined to have the following meanings:

It must be noted that, as used in the specification and the appended claims, the singular forms “a,” “an” and “the” include plural referents unless the context clearly dictates otherwise. Thus, for example, reference to “a wine component” includes mixtures of two or more such components, and the like.

“Optional” or “optionally” means that the subsequently described event or circumstance can or cannot occur, and that the description includes instances where the event or circumstance occurs and instances where it does not.

Described herein are beverages having a natural additive composed of one or more defortified wine components. In certain aspects, the beverages having a natural additive are composed of one or more defortified wine components and optional other additives.

The defortified wine components described herein can include any component present in defortified wine. Defortified wine is the final product after the alcohol (e.g., ethyl alcohol) is completely removed or substantially removed from the wine either during or after wine production. Techniques such as, for example, distillation or other dealcoholizing methods involving heat can be used to remove the alcohol. Alternatively, the alcohol can be removed during wine production or during production of the beverage as described below. After the alcohol is removed or substantially removed, the remaining composition can be used as is or further purified if necessary to produce a new beverage or supplement an existing beverage. Such techniques can include extraction, column chromatography, filtration, and the like. In certain aspects, if it is desirable to remove acids or sugars, the defortified wine components can be subjected to a base to produce the corresponding salt followed by removal of the salt.

Depending upon the wine selected, different components can be present in the defortified wine. Any wine can be used herein, with red wines as the preferred source of wine components. Using techniques known in the art, a variety of different wines can be evaluated to select the appropriate wine having the desired components. For example, high-performance liquid chromatography (HPLC) can be used to evaluate the different components present in an individual wine. The defortified wine components present in the defortified wine include, but are not limited to, polyphenols such as resveratrol, sugars, acids (e.g., tartric acid, malic acid, lactic acid, succinic acid), minerals, glycerol, sorbitol, mannitol, and vitamins occurring naturally in the wine. The amount of defortified wine and components present therein can vary depending upon the wine selected and the desired components used to produce the beverage.

The defortified wine and components present can be used to supplement existing beverages. For example, defortified wine or components thereof can be added to carbonated beverages, soft drinks, tea, fruit juice, vegetable juice, milk, water, or any combination thereof. In addition to the defortified wine or components present therein, other optional additives can be added to the beverage. For example, additives including colorants, sweeteners, glycerol, sugar alcohols, herbs, spices, additional antioxidants, flavoring agents, juices, supplementary resveratrol extracts, additional acids such as tartic, malic, lactic, and succinic acids, additional vitamins, or extracts can be used to produce new beverages. These optional additives are separate components when compared to the defortified or components present in the defortified wine.

In one aspect, the optional sweetener includes natural sweeteners. Natural sweeteners include, for example, sugar cane, sugar, molasses, sucrose, glucose, dextrose, fructose, maltose, saccharin, stevia, or any combination thereof.

In another aspect, the optional sugar alcohols include, but are not limited to, sorbitol, mannitol, or a combination thereof.

In yet another aspect, the optional herbs include, but are not limited to, gingko biloba, astragalus, green tea, and bilberry.

In a further aspect, the optional spices include, but are not limited to, cinnamon, cardamon, cloves, and ginger.

In one aspect, the optional vitamins include, but are not limited to, vitamin A, vitamin C, vitamin D, vitamin E, or any combination thereof.

In yet another aspect, the optional antioxidants include glutathione, lipoic acid, carotenoids, uric acid, ubiquinol, melatonin, polyphenolic antioxidants such as resveratrol and resveratrol extracts, or any combination thereof.

In certain aspects, one or more defortified wine components can be isolated and used in combination with defortified wine as a supplement. For example, resveratrol may be isolated and purified using techniques known in the art and used in combination with the defortified wine. In certain aspects, resveratrol can be provided as an extract in “substantially pure form.” The term “substantially pure form” covers compounds provided in greater than or equal to 80% purity, greater than or equal to 85% purity, greater than or equal to 90% purity, greater than or equal to 95% purity, greater than or equal to 98% purity, or greater than or equal to 99% purity. It also covers compounds that are diasteromerically or enantiomerically pure. Thus, in this aspect, a beverage can be supplemented with defoitified wine component in combination with isolated resveratrol.

In certain aspects, the beverages described herein contain no synthetic ingredients. For example, in one aspect, the beverages do not contain preservatives, non-naturally occurring preservatives, or any added preservatives. In other aspects, the beverages do not include pharmaceutical drugs.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

What is claimed:

1. A beverage comprising a natural additive, wherein the natural additive comprises one or more defortified wine components.

2. The beverage of claim 1, wherein the one or more defortified wine components comprises polyphenols, sugars, acids, minerals, glycerol, sorbitol, mannitol, vitamins, or any combination thereof.

3. The beverage of claim 1, wherein the one or more defortified wine components comprises defortified wine.

4. The beverage of claim 1, wherein the beverage further comprises isolated resveratrol.

5. The beverage of claim 1, wherein the beverage contains no synthetic ingredients.

6. The beverage of claim 1, wherein the beverage comprises a soft drink, a carbonated beverages, tea, fruit juice, vegetable juice, milk, water, or any combination thereof.

7. The beverage of claim 1, further comprising one or more additional additives comprising sweeteners, glycerol, sugar alcohols, herbs, spices, additional vitamins, additional antioxidants, flavoring agents, additional acids, or any combination thereof.

8. The beverage of claim 7, wherein the sweetener comprises a natural sweetener.

9. The beverage of claim 8, wherein the natural sweetener comprises sugar cane, sugar, molasses, sucrose, glucose, dextrose, fructose, maltose, saccharin, stevia, or any combination thereof.

10. The beverage of claim 7, wherein the sugar alcohols comprise sorbitol, mannitol, or a combination thereof.

11. The beverage of claim 7, wherein the flavoring agent comprises a concentrated juice.

12. The beverage of claim 7, wherein the vitamins comprise vitamin A, vitamin C, vitamin D, vitamin E, or any combination thereof.

13. The beverage of claim 7, wherein the antioxidants comprise glutathione, lipoic acid, carotenoids, uric acid, ubiquinol, melatonin, polyphenolic antioxidants, or any combination thereof.

14. The beverage of claim 7, wherein the acids comprise tartic acid, malic acid, lactic acid, succinic acid, or any combination thereof.
